(19) United States
(12) Patent Application Publication
(10) Pub. No.: US 2006/0193755 A1
(43) Pub. Date: Aug. 31, 2006

(54) Apparatus for treating recycled polyethylene terephthalate containing dense contaminants

(76) Inventors: Donald W. Hayward, Waterville, OH (US); Daniel L. Witham, Holland, OH (US)

Correspondence Address: FRASER MARTIN & MILLER LLC, 28366 KENSINGTON LANE, PERRYSBURG, OH, 43551, US

(21) Appl. No.: 10/550,328

(22) PCT Filed: Mar. 31, 2004
(86) PCT No.: PCT/US04/09764

§ 371 Date: Sep. 22, 2005

Related U.S. Application Data
(60) Provisional application No. 60/459,905, filed on Apr. 2, 2003.

(51) Int. Cl. B01J 8/18

(52) U.S. Cl. 422/139; 422/143

(57) ABSTRACT

Apparatus for treating RPET containing dense contaminants comprises a manifold positioned within a chamber, said chamber adapted to contain a fluidized bed, said manifold adapted for conveying a bed fluidizing fluid there through, a plurality of apertures in said manifold for communicating a fluid from said manifold to said chamber, said apertures positioned below the midline of said manifold, and a plurality of concave surface features on said manifold, said concave surface features positioned above the midline of said manifold, said concave surface features adapted to receive and retain dense contaminants from a fluidized bed.

### CROSS REFERENCE TO RELATED APPLICATION

This Application claims the benefit of U.S. Provisional Patent Application Ser. No. 60/459,905 filed on Apr. 2, 2003.

### FIELD OF THE INVENTION

This invention relates generally to apparatus for treating recycled polyethylene terephthalate (RPET) containing dense contaminants. More particularly, the invention is directed to apparatus for treating contaminated RPET, so that the small amounts of dense contaminants contained in the RPET may be removed from the RPET prior to further processing of the RPET.

### BACKGROUND OF THE INVENTION

Post-consumer processing of recycled PET to manufacture a variety of low-tech consumer products such as flower pots and fence posts is well-known. Typically, the recycling process utilizes used PET containers, such as discarded carbonated beverage containers, which are collected, sorted, washed, and separated from contaminants to yield a relatively clean source of RPET. Additionally, the manufacture of imperfect and damaged molded PET products, particularly the blow molded bottles used for containing consumer goods, results in a considerable amount of PET waste which the manufacturers of such products would like to reuse. The RPET produced by conventional recycling processes is generally in ground or flake form, which is thereafter melt processed or further pelletized by the end user.

RPET is generally subjected to a grinding operation in order to make the material easier to handle and process. Conventional grinding equipment reduces the RPET to about ⅜ inch particles or flakes. The grinding is conducted in a manner to insure that a consistent flake size will be produced, by employing a grate or screen through which the ground material must pass upon exiting the grinder. Although conventional RPET flakes melt processing and pelletizing equipment is designed to handle ⅜ inch flakes, some RPET materials having sizes as large as ½ inch and as small as ¼ inch are also commercially produced. The bulk density of ⅜ inch flake RPET generally ranges from about 22 to about 35 pounds per cubic foot.

RPET must be cleaned and decontaminated thoroughly in order that the RPET material may be used in the production of food grade containers such as, for example, carbonated soft drink bottles. Carbonated soft drink bottles are susceptible to failure due to even very low levels of certain dense contaminants that may accompany the RPET flake recycling process. Such dense contaminants include, for example, pieces of glass and aluminum. These two contaminants in particular are persistent in RPET due to the simultaneous collection of glass, plastic, and aluminum containers in the recycling industry. Small pieces of glass or aluminum in the RPET resin can cause defects and failures in a container produced from the RPET.

The RPET recycling industry has adopted numerous standards and procedures for reducing the concentration and effect of these types of dense contaminants. The tolerance level for glass and plastic contaminants in the production of food grade containers such as carbonated beverage bottles is very nearly zero.

Conventional polyethylene terephthalate (PET) recyclers routinely are able to reduce the level of dense contaminants such as glass and aluminum to less than about twenty parts per million. However, this level is still considered unacceptable to carbonated beverage bottle manufacturers, who typically produce billions of bottles per year.

It would be desirable to devise apparatus for treating RPET containing dense contaminants, to remove the contaminants to levels acceptable for the manufacture of food grade containers such as carbonated beverage bottles.

### SUMMARY OF THE INVENTION

Accordant with the present invention, apparatus for treating RPET containing dense contaminants has surprisingly been discovered. The apparatus comprises a manifold positioned within a chamber, said chamber adapted to contain a fluidized bed, said manifold adapted for conveying a bed fluidizing fluid there through, a plurality of apertures in said manifold for communicating a fluid from said manifold to said chamber, said apertures positioned below the midline of said manifold, and a plurality of concave surface features on said manifold, said concave surface features positioned above the midline of said manifold, said concave surface features adapted to receive and retain dense contaminants from a fluidized bed.

The inventive apparatus is particularly useful for removing dense contaminants from RPET, so that the RPET may ultimately be used to manufacture food grade containers such as carbonated beverage bottles.

### BRIEF DESCRIPTION OF THE DRAWINGS

The novel features that are considered characteristic of the invention are set forth with particularity in the appended claims. The invention itself, however, will best be understood from the accompanying description of specific embodiments, when read in conjunction with the attendant drawings, in which:

FIG. 1 illustrates fragmentary, cross-sectional, schematic view's of conventional manifolds positioned within a fluidized bed chamber; and

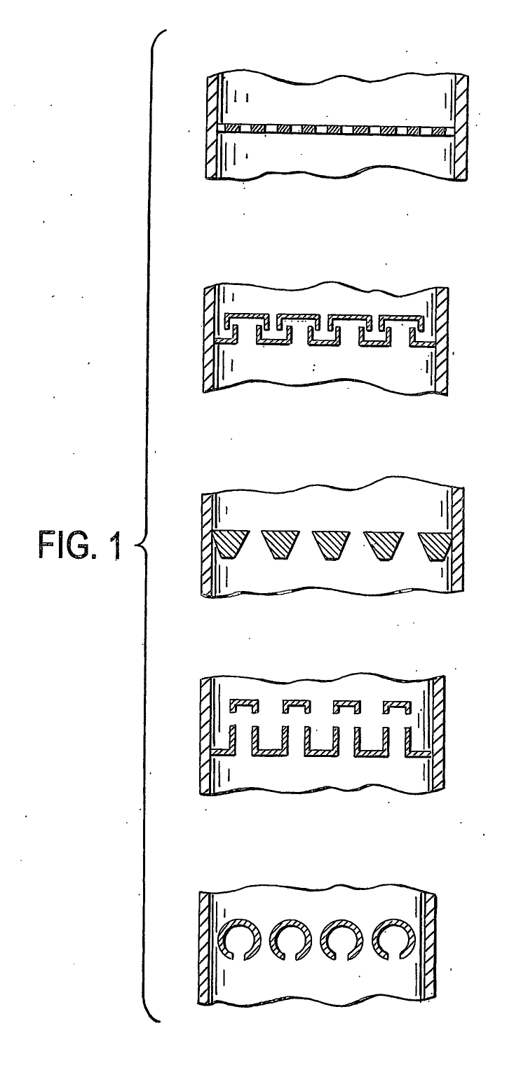

FIG. 2 is a fragmentary, cross-sectional, schematic view of apparatus according to the present invention.

### DETAILED DESCRIPTION OF THE PREFERRED EMBODIMENT

The present invention is directed to apparatus for treating RPET containing dense contaminants, comprising a manifold positioned within a chamber, the chamber adapted to contain a fluidized bed, the manifold adapted for conveying a bed fluidizing fluid there through, a plurality of apertures in the manifold for communicating a fluid from said manifold to the chamber, the apertures positioned below the midline of the manifold, and a plurality of concave surface features on the manifold, the concave surface features positioned above the midline of the manifold, the concave surface features adapted to receive and retain dense contaminants from a fluidized bed.

According to the present invention, a quantity of RPET flakes containing dense contaminants is provided for further processing. The RPET flakes are comminuted by any conventional means to prepare RPET particles having an average mean particle size that may be fluidized in a fluidizing chamber; as low as about 300 microns. These particles may then be treated by the inventive apparatus to separate the dense contaminants from the RPET particles.

The inventive apparatus, generally indicated by reference numeral 10 comprises a manifold 12 positioned within a chamber 14 adapted to contain a fluidized bed of RPET particles. The illustrated manifold 12 is comprised of tubes having an elongate arcuate upper surface extending along the longitudinal axis of the tube. However, the invention contemplates the use of manifold tubes of any cross sectional shape. The manifold 12 is adapted for conveying a fluid there through for fluidizing a fluidized bed within the chamber 14.

The manifold 12 contains a plurality of apertures 16 for communicating a fluid from the manifold 12 to the chamber 14. These apertures 16 are positioned below the midline 18 of the manifold 12.

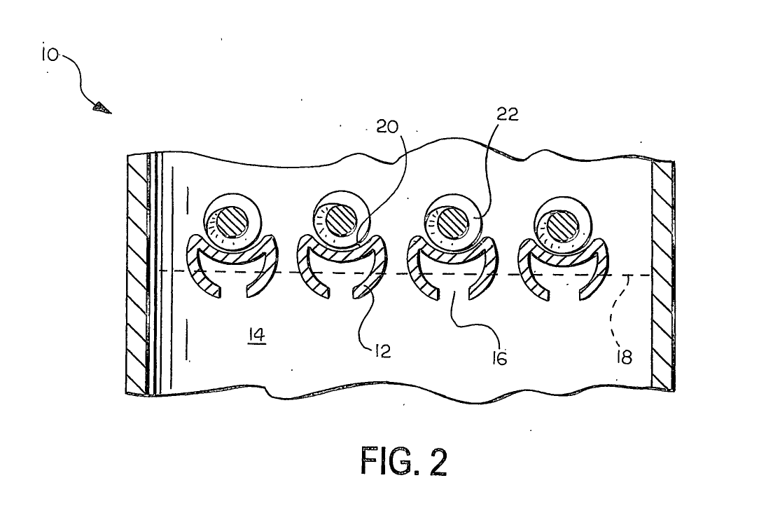

The manifold 12 contains a plurality of concave surface features or surfaces 20 which are designed to receive and retain dense contaminants that sink to the lower regions of the fluidized bed. Arcuate concave surface features 20 are illustrated in FIG. 2, although the invention contemplates the use of surface features having any concave configuration. The concave surface features 20 are positioned above the midline 18 of the manifold 12.

Conveniently, a removal device, such as a series of augers 22, or a series of plungers (not shown), may be employed in the inventive apparatus for removing the collected dense contaminants from the concave surface features 20 of the manifold 12, during operation of the fluidized bed.

In operation, the dense contaminants descend through the fluidized bed of RPET and collect in the concave surface features 20 of the manifold 12. This is an area of very low gas velocity, where the dense contaminants collect and are retained until removed. Removal may be accomplished by incorporating an automatic removal means such as the augers 22, or manually such as by collapsing the fluidized bed and separating the dense contaminants.

The apparatus for treating RPET which contains dense contaminants described hereinabove is generally disclosed in terms of its broadest application to the practice of the present invention. Occasionally, the process conditions and apparatus features as described may not be precisely applicable to each RPET particle/contaminant combination included within the disclosed scope. Those instances where this occurs, however, will be readily recognized by those ordinarily skilled in the art. In all such cases, the process may be successfully performed by conventional modifications to the disclosed apparatus and method.

The invention is more easily comprehended by reference to the specific embodiments recited hereinabove which are representative of the invention. It must be understood, however, that the specific embodiments are provided only for the purpose of illustration, and that the invention may be practiced otherwise than as specifically illustrated without departing from its spirit and scope.

What is claimed is:

1. Apparatus for treating RPET particles containing dense contaminants, comprising:
a manifold having a midline and positioned within a chamber containing a fluidized bed, said manifold adapted to convey the fluidized bed therethrough;
a plurality of apertures in said manifold for directing a fluid from said manifold to the chamber, said apertures positioned below the midline of said manifold; and
a plurality of concave surface features on said manifold, said concave surface features positioned above the midline of said manifold, said concave surface features adapted to receive and retain dense contaminants from the fluidized bed.

2. The apparatus for treating RPET particles according to claim 1, wherein the manifold comprises arcuate shaped tubes.

3. The apparatus for treating RPET particles according to claim 1, wherein the concave surface features of said manifold have an arcuate shape.

4. The apparatus for treating RPET particles according to claim 1, further comprising a removal device for removing dense contaminants from the concave surface features on said manifold.

5. The apparatus for treating RPET particles according to claim 4, wherein the removal device comprises a series of augers.

6. The apparatus for treating RPET particles according to claim 4, wherein the removal device comprises a series of plungers.

7. Apparatus for treating RPET particles containing dense contaminants, comprising:
a manifold having a midline positioned within a chamber containing a fluidized bed, said manifold adapted to convey the bed fluidized bed therethrough;
a plurality of apertures in said manifold for directing a fluid from said manifold to the chamber, said apertures positioned below the midline of said manifold;
a plurality of concave surface features on
said manifold, said concave surface features
positioned above the midline of said manifold, said concave surface features adapted to receive and retain dense contaminants from the fluidized bed; and
a removal device for removing dense contaminants from said concave surface features on said manifold.

8. The apparatus for treating RPET particles according to claim 7, wherein the removal device comprises a series of augers.

9. The apparatus for treating RPET particles according to claim 7, wherein the removal device comprises a series of plungers.
